(19) United States
(12) Patent Application Publication
(10) Pub. No.: US 2020/0347790 A1
(43) Pub. Date: Nov. 5, 2020

(54) NON-COMBUSTIBLE FLUID INJECTION METHOD FOR AN INTERNAL COMBUSTION ENGINE

(71) Applicant: Hitachi Automotive Systems, Ltd., Hitachinaka-shi, Ibaraki (JP)

(72) Inventors: Takashi OKAMOTO, Hitachinaka-shi (JP); Naoki YONEYA, Tokyo (JP)

(73) Assignee: Hitachi Automotive Systems, Ltd., Hitachinaka-shi, Ibaraki (JP)

(21) Appl. No.: 16/762,240

(22) PCT Filed: Jan. 24, 2019
(86) PCT No.: PCT/JP2019/002371

§ 371 Date: May 7, 2020

(30) Foreign Application Priority Data
Jan. 25, 2018 (DE) 10 2018 201 152.4

(51) Int. Cl. F02D 35/02; F02M 25/03

(52) U.S. Cl. CPC F02D 35/023; F02M 25/0227; F02M 25/03

(57) ABSTRACT

Method for controlling injection of a non-combustible fluid into an internal combustion engine. The internal combustion engine may include at least one cylinder, at least one non-combustible fluid injector, at least one combustion phase determining means, and at least one control unit. The method may comprise the steps of determining the combustion phase by the combustion phase determining means, determining the amount of non-combustible fluid to be injected depending on the combustion phase.

### TECHNICAL FIELD

The present document relates to a method for injecting a non-combustible fluid into an internal combustion engine, a corresponding control unit of an internal combustion engine, and a computer program product for carrying out the method by means of a computer. It is a particular technical advantage of the claimed subject-matter that the injected amount of water can be more precisely matched to the real state of the combustion within the internal combustion engine.

### BACKGROUND ART

Water injection is an effective measure for the prevention of knocking in state of the art vehicle-internal combustion engines. In addition, the injection of water into the internal combustion engine can reduce the fuel consumption of the internal combustion engine. So far, the water injection control and especially the determination of the water amount to be injected is based on feed forward control, such as described by patent literature 1.

### CITATION LIST

### Patent Literature

PTL 1: JP 2012-112326 A.

### SUMMARY OF INVENTION

### Technical Problem

Patent literature 1 describes a diesel engine as an internal combustion engine of a vehicle and an amount of water to be injected is calculated by the loss of exhaust energy within a feed forward control system. The water injection is performed during the combustion phase of the diesel engine.

A downside of water injection methods and devices known so far is that the water tank has to be rather large and/or that the water has to be refilled in relatively short time intervals because the injected amount of water is not accurately determined.

The claimed subjected matter according to the appended claims overcomes the above technical problem and provides a method for controlling the amount of noncombustible fluid injected into an internal combustion engine more precisely. Further, a corresponding control device and a software program product are entailed, too.

### Solution to Problem

According to an aspect, the claimed subject matter comprises a method for controlling the injection of a non-combustible fluid into an internal combustion engine. Preferably the non-combustible fluid is not/not fully combusted (i.e. at least partially inert) during the combustion within a cylinder of an internal combustion engine. More preferably, the non-combustible fluid is a gas or liquid with a high latent heat, wherein the latent heat of the fluid is at least 1/10 of the evaporation enthalpy of water. Most preferably, the non-combustible fluid is water.

The internal combustion engine may include at least one (combustion) cylinder, at least one non-combustible fluid injector, at least one combustion phase determining means, and at least one control unit.

Preferably, the at least one non-combustible fluid injector is a water injector and preferably it is disposed so that the non-combustible fluid/water is injected into the cylinder. In this case, it is preferable to provide at least one water injector per cylinder of the internal combustion engine. Alternatively or in addition, the at least one noncombustible fluid injector can be arranged at an air intake port of the internal combustion engine so that the non-combustible fluid is injectable into the air intake port/duct. It may be preferably to have at least one intake port per cylinder.

The at least one control unit may be integrated into the internal combustion engine or, alternatively, the control unit may be disposed at a position within a vehicle remote to the internal combustion engine and the control unit and the internal combustion engine may be connected via one or more signal lines.

Preferably, the non-combustible fluid (or shortly fluid) is not injected during the combustion phase of the combustion cycle. In other words, the fluid is preferably injected when the combustion is not taking place. The even more preferred timing for injecting the water is during the time of the intake of air.

The method may in particular comprise a step of determining a combustion phase by the combustion phase determining means, and a step of determining the amount of non-combustible fluid to be injected depending on the (determined) combustion phase. The term “determining” may preferably include the meanings of “calculating” as well as “estimating”. Preferably, determining the combustion phase may include that the timing of the combustion phase within the combustion cycle may be determined, and preferably the injected amount is determined based on said determined timing. In this regard it shall further be understood, that the “determining” of the amount of fluid to be injected may also include the meaning that an amount of fluid to be injected (which was somehow known before) is corrected or adjusted.

The determined combustion phase is the “real” combustion phase, wherein “real” shall be understood as being distinguished from a target or target combustion phase. In other words, in known systems, a target combustion phase for injecting, e.g., water into the internal combustion engine is predefined and the injection is carried out based on a feedforward control without having the possibility to check whether the actual or real combustion phase is deviated or shifted; e.g., the combustion phase may be shifted such as to be delayed. To the contrary, the claimed method which is described herein enables to get to know the actual/real combustion phase (or its timing) and thus can adapt the injection amount of non-combustible fluid accordingly. The method including the above described steps hence allows injecting an amount of noncombustible fluid into the internal combustion engine which is highly accurate and precisely matched to the real combustion phase/conditions. This allows, i.a., to save non-combustible fluid, such as water, which has to be carried within the vehicle and which has to be refilled repeatedly. In other words, it may either be beneficially possible to reduce the size of the tank for the non-combustible fluid and/or to expand the refill intervals.

Further, the combustion phase determining means may determine (or calculate or estimate) a pressure in the at least one cylinder. If there is more than one cylinder, the means may either determine the pressure in the plurality of cylinders or there may be at least one combustion phase determining means per cylinder. The control unit may determine the (real) combustion phase by comparing said determined (real) pressure with a target pressure, e.g., for the combustion phase. In other words, by determining the pressure and comparing it with a target pressure (e.g. at a preset time or position of the combustion cycle or phase), it is possible to detect the timing of the combustion phase which means that the real combustion phase is determined and whether it is, e.g., delayed.

One combustion (power) cycle may include several strokes. The pressure may be mapped to the crank angle, to a time or another variable. If, e.g., the pressure is mapped to the crank angle, the target pressure may be set so that it is possible to determine a shift of the combustion phase by comparing the target pressure at a preset crank angle with the real pressure at said crank angle. If the real pressure and the target pressure deviate from each other at the preset crank angle, the combustion phase is determined to be shifted, i.e. advanced or delayed. Alternatively, the real pressure may be compared with the target pressure to extract the crank angle at the point where the real pressure and the target pressure match with each other. Then, a shift of the combustion phase is determined, e.g., when the crank angle at which the two pressures match with each other deviates from a predefined crank angle. Further, instead of the crank angle in the above examples, it may also be used a certain time after a predefined event or any other variable which allows setting a point during the combustion cycle at which the (combustion) pressures can be compared with each other.

For example, preferably, the target pressure may be set to coincide with 50% of the total burn rate (MFB50) of the combustion within the cylinder. More specifically, it may be defined that the target pressure is a certain numerical value which is expected (e.g. by experiments, analysis, simulation or the like) at MFB50 which is set to be at e.g. a crank angle of 6° or 8° or the like after the top dead center (TDC) during the combustion phase. Then, in this example, if the preset pressure should be detected at another crank angle, e.g., 10°, it would be detected that the combustion phase is shifted. Alternatively, in this example, if, at the preset crank angle of, e.g., 8°, the determined (real) pressure deviates from the target pressure, it can be determined that the (real) combustion phase is shifted compared to the (target) combustion phase.

Comparing the determined/real pressure with the target pressure may show that, e.g., the combustion phase is advanced or delayed compared to the target and, thus, if the injection would be carried out according to the predefined amount which is set based on the target, too much or not enough fluid would be injected. Especially, the first case would mean that too much fluid is injected and that the reservoir/tank would be emptied quickly. Having determined the real/actual combustion phase by determining the real/actual pressure, the amount of injected fluid can be reduced which leads to the technical advantages discussed above.

Further, the control unit may determine an amount of the non-combustible fluid to be injected by feedforward control. This may, e.g., take place during a first combustion cycle after starting the engine, after starting the fluid injection control or after/at any other predefined point in time. The feedforward control may in particular include that the water injection amount is determined, e.g., based on using a lookup table, a map, a predefined equation or the like. For this part of the control process determination parameters are used which allow determining the engine's condition/state and correlating/determining an amount of fluid to be injected thereto. For example, a map may be used which includes an axis on which the engine revolutions are plotted and an axis on which the engine load is plotted. Depending on the actual condition of the engine, e.g., indicated by values for the above exemplarily mentioned parameters (revolutions and load), the map may return a value for an injection amount. The amount of injected non-combustible fluid (or simply fluid) may be expressed in different ways, however, preferably the amount is expressed in terms of a pulse width for driving the fluid/water injector.

After having determined/subsequent to the above described determining of the injection amount, the amount may be corrected. The correction preferably happens at the subsequent combustion cycle, however, this may be varied. The amount of fluid to be injected may be corrected based on the determined combustion phase by feedback control. Here, feedback control shall in particular entail the use of a comparison between the target (predefined) pressure and the pressure that was determined, i.e. the real/actual pressure. The comparison between the two pressure values delivers information about the real combustion phase or the real state of the combustion, i.e. whether the combustion phase is advanced or delayed. Especially and preferably, in case of a delayed combustion phase, the correction is carried out to reduce the amount of fluid to be injected. In other words, the result of the feedforward control in view of the amount of fluid to be injected is adapted to the real/actual combustion conditions/phase based on the result of the feedback control which includes the determining of the real combustion phase by comparing the target pressure and the real/actual determined pressure.

Further, the method, which may be preferably carried out by one or more control units, e.g. the engine control unit (ECU), may preferably include to determine the amount of non-combustible fluid to be injected based on a predefined engine state/condition, such as the load of the engine or a multi-parameter-defined state using, e.g., the load and the number of revolutions. The method may further determine the above discussed real pressure within the cylinder which may preferably be done by the combustion phase determining means itself or by the control unit based on values determined/measured by the combustion phase determining means. Said means may be a pressure determining means. Even further, the method may include the step of comparing said determined pressure with the target pressure in order to determine the (real) combustion phase thereby or therewith. Depending on the comparison result, the amount of non-combustible fluid to be injected may then be corrected based on the comparison result. The method may be carried out with little additional hardware parts and computing effort compared to the known methods, however, it increases the accuracy of the fluid injection amount strongly which leads to the technical benefits that a non-complex system may improve the efficiency of using the non-combustible fluid so that refill intervals or tank sizes may be increased and reduced, respectively.

Further, especially the steps of determining the pressure within the cylinder, comparing the determined pressure with a target pressure and correcting the amount of non-combustible fluid to be injected may be carried out in a preferably repeated fashion or a loop. More preferably, this “control loop” may be repeated at least once during one combustion cycle. The amount to be corrected may preferably be the first amount determined by the feedforward control. Alternatively, the amount to be corrected may be the amount which is the amount of the directly preceding combustion cycle or control loop. For the correction, preferably, the (corrected) amount of noncombustible fluid to be injected is stored for using it during a subsequent combustion cycle. The storage means may be, e.g., a member of the control unit. However, the storage means may also be located elsewhere.

The method steps and especially the “control loop” steps may be carried out within the control unit, e.g., by using a computing unit, a processor, or any other processing unit of the control unit.

Repeating the control ensures that the amount of injected non-combustible fluid stays precise even if the combustion phase should shift more than one time.

Further, as noted before, the control unit may reduce the amount of non-combustible fluid to be injected compared to the amount determined by feedforward control when the determined (real) combustion phase is retarded compared to the target combustion phase. The variation/correction of the injection amount may be carried out by a separate unit, a sub-unit of the control unit or the control unit which using a correction means, such as a correction map, a correction lookup table, an equation or the like. The computing efforts may be reduced by the latter means.

Further, the combustion phase determining means may be a pressure sensor installed at least partially within the cylinder. Alternatively or in addition, a crank angle sensor obtaining a crank angle may be used. Based on signals/values submitted/measured by the sensor(s), the control unit or any other processing means may calculate/determine the combustion pressure. In case that a pressure sensor is used, the computing effort for determining the pressure is lower for the control unit, however, installing the pressure sensor in the cylinder may increase the system complexity. Using the crank angle sensor, the computing effort is slightly higher, however, the system complexity of the hardware, i.e. within the internal combustion engine, is lower compared to the pressure sensor installed in the cylinder. Nevertheless, determining the real pressure can be efficiently performed and thus the real combustion phase can be determined at low computing costs, reliably and quickly.

Further, the internal combustion engine is preferably a gasoline engine and further preferably the injected fluid is injected outside of the combustion phase of the engine improving the fuel efficiency.

Further, the claimed subject matter may include a control unit of an internal combustion engine, preferably the ECU, which may be configured to carry out the method according to the above described method/aspects of the method, as well as an internal combustion engine which may include the control unit. “Include” may mean that the control unit is physically integrated with the engine or that it is remotely arranged, however, connected thereto by signal lines and the like.

Further, the claimed subject matter may include a computer program product storable in a memory comprising instructions which, when carried out by a computer or a computing unit, cause the computer to perform the above described method or aspects thereof, as well as a computer-readable storage medium comprising instructions which, when executed by a computer, cause the computer to carry out said method or aspects thereof.

### Advantageous Effects of Invention

Summarizing, the claimed subject-matter allows reducing the amount of water being used in a water-injection internal combustion engine, in particular when the combustion phase of the internal combustion engine is delayed.

In the following the claimed subject-matter will be further explained based on at least one preferential example of the invention with reference to the attached exemplary drawings, wherein:

### BRIEF DESCRIPTION OF DRAWINGS

FIG. 1 depicts a cross-sectional view of a parts of an internal combustion engine;

FIG. 2 depicts a water injection device;

FIG. 3 depicts a control system of the claimed control method;

FIG. 4 depicts a flow chart of the claimed control method;

FIG. 5 depicts an example of a curve which shows the amount of water to be injected compared to the timing of the combustion phase;

FIG. 6A shows cross sections of a cylinder 100 with a crank angle sensor;

FIG. 6B shows a flow chart of a claimed method for determining the combustion pressure based on the crank angle sensor signals.

### DESCRIPTION OF EMBODIMENTS

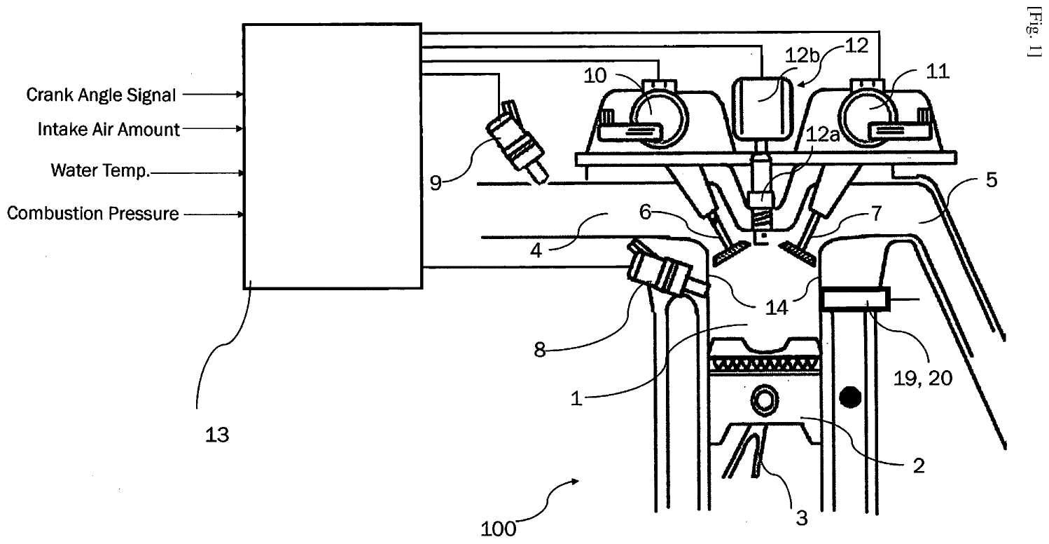

FIG. 1 depicts an exemplary cylinder 100 of an otherwise unspecified internal combustion engine, which may have more than one cylinder 100. The engine may, for example, have two, three, four, six, eight or less/more cylinders 100. The cylinder 100 comprises a combustion chamber 1 in which a piston 2 with a connecting rod 3 is disposed allowing it to travel. The connecting rod 3 is connected to a crankshaft 25 that is described later in connection with an aspect of determining the pressure within the combustion chamber 1 of the claimed subject-matter.

An (air) intake port 4 with an intake valve 6 as well as an exhaust port 5 with an exhaust valve 7 are connected to the combustion chamber 1. Ambient air is drawn into the combustion chamber 1 through the intake port 4. Exhaust gases are discharged from the combustion chamber 1 via the exhaust port 5. A spark ignition unit 12 comprising a spark plug 12a and an ignition coil 12b is attached to the internal combustion engine. The spark ignition unit 12 preferably offers a variable spark duration or multi-spark ignition. The internal combustion engine (or briefly: “combustion engine” or “engine”) may have one or more spark ignition units 12. Preferably, it has at least one spark ignition unit(s) 12 per cylinder 100. The spark plug 12a as well as a fuel injector 8, or at least parts thereof, are connected to the inside of the combustion chamber 1 so that a spark and fuel can be introduced/injected into the combustion chamber 1. The high-pressure fuel supply of the fuel injector 8 is not depicted. The fuel injector 8 may preferably be a direct fuel injector 8. Further, the fuel injector 8 may preferably be an electrohydraulic fuel injector or a piezoelectric fuel injector.

The internal combustion engine may be equipped with one or more intake valve phasing actuator(s) 10 and/or one or more exhaust valve phasing actuator(s) 11 as shown in FIG. 1. The intake valve phasing actuator 10 is preferably used for realizing early intake valve closing. The exhaust valve phasing actuator 11 is preferably used for adjusting residual gas and/or for varying an exhaust valve opening timing. The valve phasing actuators 10, 11 are preferably hydraulic actuators or electric actuators. Other means for controlling the intake and exhaust valve opening/closing timings may be applied in addition or alternatively. Even further, if not otherwise indicated in the aspects described below, the herein claimed subject-matter may also entail an internal combustion engine which does not have an intake/exhaust valve opening/closing timing means.

Further, a non-combustible liquid injector 9 is connected to the intake port 4 of the cylinder 100. Since most preferably the liquid to be injected is water, even though other liquids having a high evaporation enthalpy may be used as well, the term “water injector” will be used as one specific example for a non-combustible liquid injector 9. The water injector 9 may be a low-pressure injector with an injection pressure of up to 4 bar or a high-pressure injector with an injection pressure of more than 4 bar. As an alternative to the water injector 9 connected to the intake port 4 (as shown in FIG. 1), or in addition thereto, one or more water injectors 9 may be connected to the cylinder wall 14 of one cylinder 100 to inject water directly into the combustion chamber 1.

Further, FIG. 1 shows a controller 13 which is electrically connected to the spark ignition unit 12, the valve phasing actuators 10, 11, the direct fuel injector 8 and the water injector 9. As an example, input signals, such as a crank angle signal, an intake air amount, a water temperature and a combustion pressure, are shown in FIG. 1. However, other input signals or more or less input signals may be input into the controller 13. The controller 13 controls the multiple units/injectors/actuators. The controller 13 may, for example, be the engine control unit (ECU). The controller 13 may also be any other control unit, and signal line connections between the controller 13 and the controlled units may differ from the example of FIG. 1. For example, there may be a plurality of controllers 13 which can control subgroups of the controlled units, e.g. one controller 13-1 may control only fuel injectors, another controller 13-2 may control only water injectors 9 and so on. Even further, if there is a plurality of controllers 13, these controllers 13 can be interconnected with each other hierarchically or in another way.

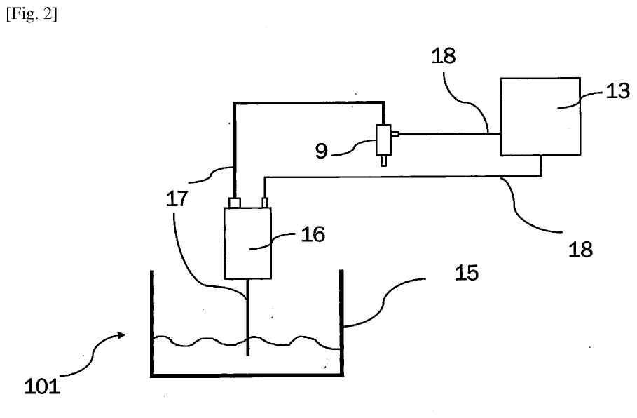

FIG. 2 shows a water injection device 101 of an aspect in which the non-combustible fluid is water. The water injection device 101 has a water tank 15, a water pump 16 which can supply water from the water tank 15 to the water injector 9 via a water pipe/tube 17. The water injector 9 and the water pump 16 are electrically connected with the controller 13 via signal lines 18. The controller 13 may, inter alia, control the injection pulse width/time, the injection pressure and/or the injection timing. For example, the controller 13 may be adapted to vary the injection pulse width/time so that the amount of water being injected into the engine may be varied. As described above, the water injector 9 may be arranged so that water may be injected directly into the combustion chamber 1. Alternatively or additionally, the water injector 9 may be connected to the intake port 4 so that water may be injected into the stream of air sucked into the combustion chamber 1. The water may further be injected so as to form a (homogenous) mixture of air and water.

The water injection device 101 according to FIG. 2 is a schematic example which may include further non-shown and/or optional members, such as a fluid rail for connecting multiple water injectors 9, such as sensors for temperature, pressure and the like, such as further signal lines, such as further water lines/tubes for recirculation of water or the like, such as valves, and/or such as further actuators, pumps and the like.

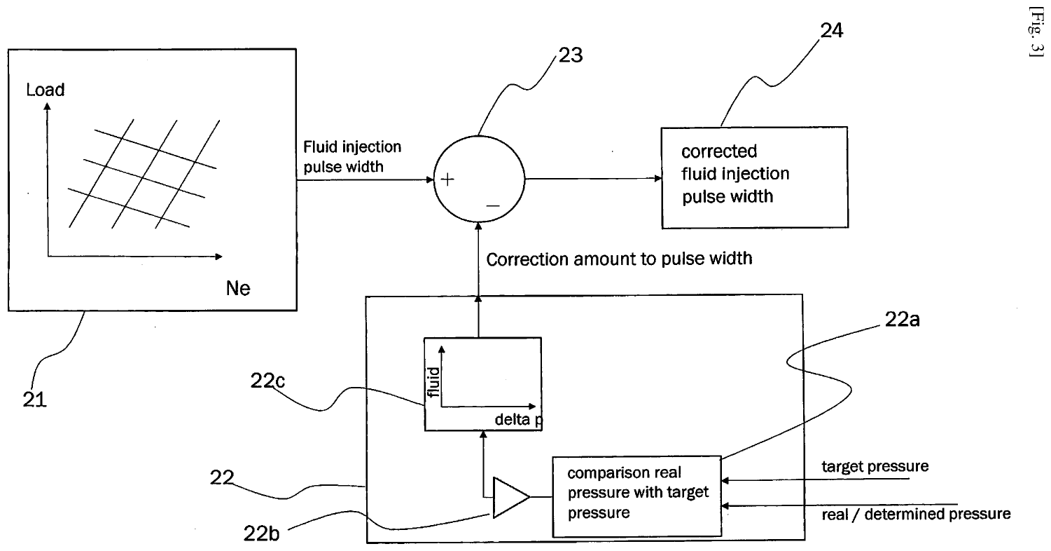

FIG. 3 shows an aspect of the control method which is used particularly for varying the amount of non-combustible fluid, e.g. water, which is injected into the internal combustion engine. A feedforward control section 21 is used to set an amount of water to be injected, preferably by way of setting a fluid injection control pulse width/time duration. The feedforward control section 21 (and the other sections shown in FIG. 3) can be realized as part of the controller, as a subunit thereof, as stand-alone computing units or the like. The feedforward control section 21 may set the water injection amount or the corresponding control pulse based on (predefined) states or conditions of the engine. For example, this may be done based on predefined internal combustion engine state parameters, such as the number of revolutions, load and the like. In FIG. 3 there is shown an example in which the feedforward control section 21 uses a map which includes the parameters of the number of revolutions (Ne) and the engine load for setting the amount of water to be injected (via setting the control pulse). The feedforward control section 21 may include a plurality of such maps which may also include other parameters. Further, the feedforward control section 21 may, additionally or alternatively, include tables which may be read for setting the water amount/control pulse. In addition or instead, the feedforward control section 21 may also use other means for setting the amount of water/control pulse to be injected at a predefined driving situation and an internal combustion engine state, respectively.

The feedforward control section 21 outputs a control signal indicating at least a value for the amount of water to be injected. Preferably, the amount of water to be injected is expressed by way of a pulse width/time duration. The signal output by the feedforward control section 21 is input into a merging unit 23 which further receives at least an output (signal) from a feedback control section 22. The merging unit 23 may combine the two signals which are input thereto. For example, FIG. 3 shows that the output from the feedback control section 22 is subtracted from the output of the feedforward control section 21. This will be described in more detail below.

The feedback control section 22 may include various optional sub-sections. One example of a preferred configuration of the feedback control section 22 is schematically depicted by FIG. 3. It shows that it at least receives input (signal) indicating a target pressure and a real/determined pressure. With the input received at the feedback control section 22, the combustion phase may be determined. With the input received at the feedback control section 22, e.g., it may be checked whether the combustion phase of the combustion cycle is present at the moment of the checking, and, preferably, with the received input at the feedback control section 22 it may be determined whether the combustion phase deviates from the regular timing, i.e. whether the combustion phase is ahead of the timing or delayed/retarded. This may be carried out, as a preferred example, by comparing the target pressure with the determined/real pressure. For example, it may be defined that the pressure at a specified time of the combustion cycle and/or at a specified crank angle, shall have a given value or shall be within a given range of values which is then the target pressure. The target pressure may be read from a table, a map or the like which may be stored in the controller's memory. Further in the above example, the target pressure may indicate a predefined state of the combustion cycle so that it is possible to find out whether the combustion phase is delayed or ahead of the timing when it is measured whether the real pressure at a predefined state matches with target pressure or not. In other words, the target pressure may be any pressure during the combustion cycle based on which it may be find out whether the combustion cycle or the combustion phase thereof is ahead, “on time” or delayed/retarded. A specifically preferred target pressure may be the pressure which is expected at a burn rate of 50% of the total burn rate (MFB50) or which is expected at a crank angle in a range of 6° to 10° or at a specific value, such as 6° or 8°, after the top dead center during the combustion phase of the combustion cycle.

The real or determined pressure is a pressure which was measured by a pressure determining means 19. This may, for example, be a pressure sensor 20 being arranged (at least partially) within the combustion chamber 1 (as schematically shown in FIG. 1) which determines or measures the pressure within the combustion chamber 1. A further preferred option for a configuration/aspect of the pressure determining means 19 will be described later. The pressure determined by the pressure determining means 19 may be directly submitted by way of a signal to the feedback control section 22 or it may be sent via a/the controller 13.

The feedback control section 22 has at least one comparison section 22a which is adapted to compare the two input pressure values described above. The comparison section 22a may be a CPU or the like or it may be a specifically designed electrical circuit for comparing two values with each other and to output a comparison result. In the present example, the output of the comparison section 22a may preferably be a pressure difference value (delta p) indicating a difference between the two input pressure values. If the pressure difference delta p is unequal zero, the combustion cycle timing is either ahead or delayed in timing. If the timing is ahead or delayed, the feedback control section 22 will output a correction amount (signal) which is input into the merging unit 23. For example, if the timing/combustion phase is found to be delayed, the feedback control section 22 will output a correction amount signal for reducing the amount of water to be injected which was set by the feedforward control section 21. Further, preferably, the feedback control section 22 may include a varying section 22c which may include computing means for determining/calculating/estimating the correction amount to be output by the feedback control section 22. The varying section 22c may use tables, maps or other options, such as equations and the like, for finding the correction amount. In FIG. 3, a look-up map is shown as an example. If the varying section 22c is not included in the feedback control section 22, the determining/calculating/estimating of the correction amount may be carried out outside of the feedback control section 22, e.g. within one of the controller(s) 13. A further preferable sub-section of the feedback control section 22 may include a gain 22b which may be preferably set between the comparison section 22a and the varying section 22c.

As already described above, the merging unit 23 combines the at least two input values, the feedforward-control-set water injection amount (preferably expressed as a control pulse width/duration time) and the correction amount input from the feedback control section 22. After the combination, carried out by CPUs or specific electrical circuitry of the merging unit 23, the merging unit 23 outputs a corrected amount, e.g. such as a corrected fluid injection pulse width, to the controller 13 which controls the water injector 9. Alternatively, the output may performed by an optional output unit 24 which passes the control signal to the controller 13 which controls the water injector 9. By the above described combination of feedforward and (closed-loop) feedback control of the water injection amount, a higher accuracy of the precise amount of water to be injected into the internal combustion engine can be achieved. Especially when the combustion cycle is shifted, e.g. delayed, the water amount can be accurately adjusted and water is saved to the benefit of the water use efficiency.

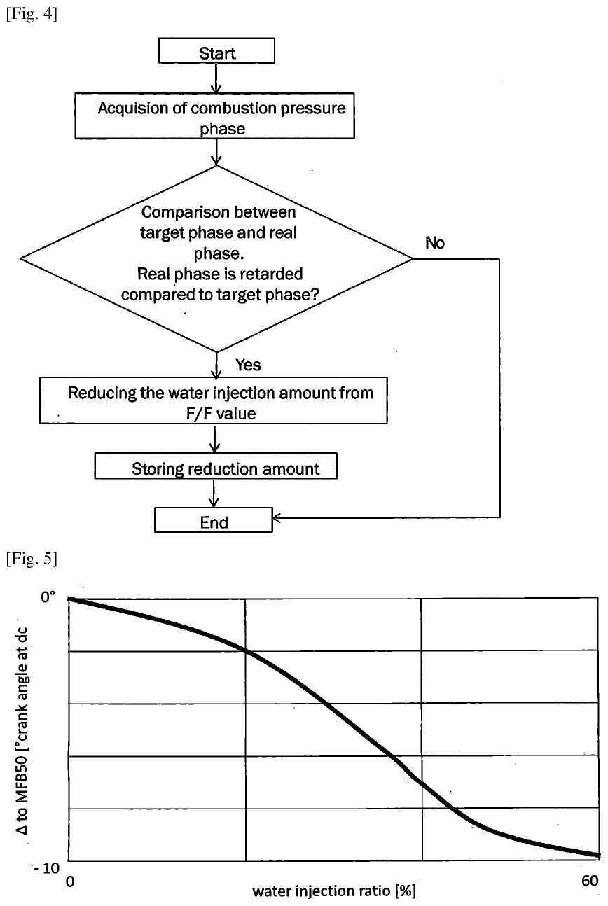

FIG. 4 further describes an example for a series of steps to be carried out when performing the control method as claimed. In a first step, the combustion pressure phase is determined. This particular includes the measurement/determination/calculation of the real pressure by means of the pressure determining means 19, which may comprise, in an aspect of the claimed subject-matter, one or more pressure sensors included in the cylinder 100 or the combustion chamber 1 thereof. With this step completed, the determined pressure is compared with the pressure of the target. The target may be the pressure at the point of 50% total burn rate (MFB50) or at a crank angle of 6°, 8° or 10° or the like after the top dead center during the combustion phase. If the two pressure values match with each other, the combustion phase is determined and, more specifically, it is determined that the combustion phase is on time. If the two pressure values do not match, it is checked in this step or in a sub-step whether the combustion phase is delayed/retarded. If this is found, the further steps of a feedback control are carried out by which the water amount to be injected is reduced. FIG. 4 only shows a reduction of the water amount when a delay of the combustion phase is found. According to an aspect, there may be only a step of reducing the injected water amount when a delay of the combustion phase is found. In another aspect, however, the correction may also be carried out when the combustion phase is earlier, i.e. ahead of the timing.

With the correct/corrected water injection amount being set, either by correction (yes-route in FIG. 4) or by feedforward control only (no-route in FIG. 4), the water injector 9 is controlled to inject the set amount. Preferably, the injection takes place outside of the combustion phase, and, most preferably, it takes places during the intake of air before the combustion phase. The reduction amount of the present loop is stored so that it can be used as a starting point for the next loop of the above described steps.

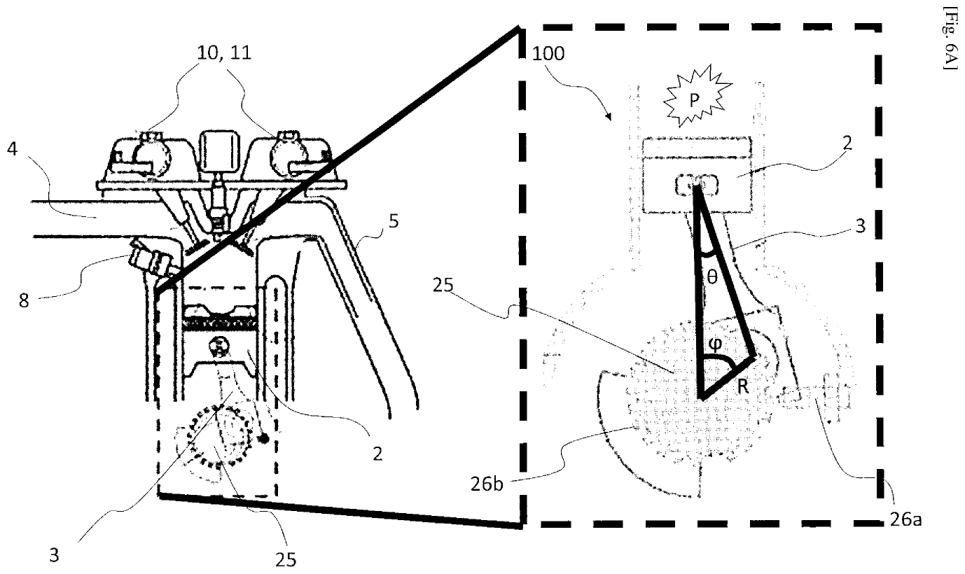

FIG. 5 shows the example of a curve which relates the amount of water in the air, as a water air ratio, to the deviation from MFB50 expressed as difference degree of the crank angle. The curve previously determined schematically indicates a trend which corroborates that the accuracy of the determination of the combustion phase has a considerably effect on the injected water amount. In other words, if it is determined that the combustion phase is delayed by 1°, the injected water amount can be reduced by up to approx. 6%. The claimed subject-matter therefore allows saving a considerable amount of water due to the above-described method of correcting the water injection amount based on real/determined pressure values.

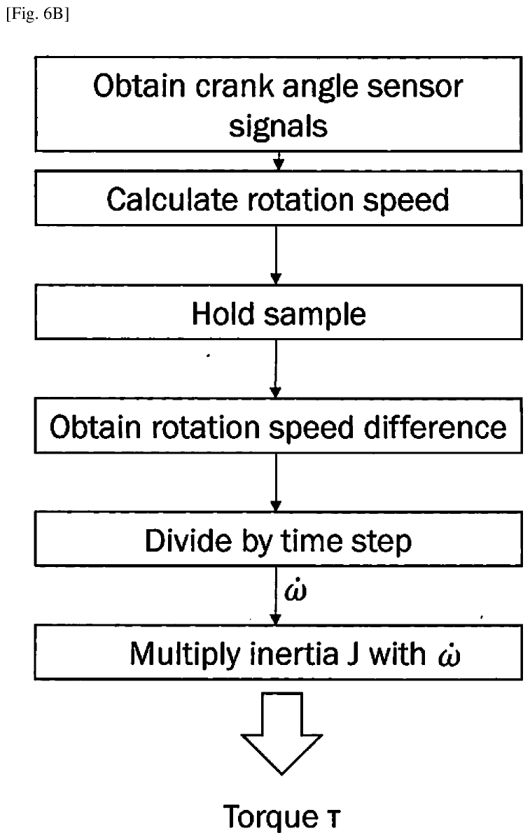

FIGS. 6A and 6B further show an aspect for determining the pressure within the combustion chamber 1 based on the crank angle of the crankshaft 25 which preferably has teeth 26b in this aspect. The steps may be performed in a different order. For performing this determination method, the pressure determining means 19 has at least one detector 26a for detecting the teeth 26b, as schematically shown in FIG. 6A. The detector 26a may preferably count the teeth 26b by way of optical means or by way of magnetic fields or the like, as an example. The detector 26a may be disposed in a space close to the crank shaft 25. As shown in FIG. 6B, the one or more controller(s) 13 may obtain the sensor signals from the detector 26a in a first step. Subsequently, the sensor signals, such as pulse signals, are used to calculate the rotational speed of the crankshaft 25 and after this step, the sample, i.e. the crankshaft 25, may be held or stopped (it is also possible to measure the rotational speed difference in a different way without stopping the sample). Then a difference between the rotational speeds is obtained and it is divided by the time step/period between the two rotational speed values with which the difference was build, and the resulting value (the first derivative of w) is multiplied by the inertia, which will have the sign “J” in the following. By these steps as shown in FIG. 6B, the torque “τ” of the crankshaft 25 is determined/calculated based on the following equation (1):

J\dot{ω}=τ_{combustion}+τ_{friction}+τᵢₙₙₑᵣ+τᵢₙₙₑᵣ+τ_{load} [Math. 1]

With the value for the torque T, combustion pressure p can be calculated based on the following equation (2):

$$p = \frac{τcos θ}{{A}_{cylinder} R sin ( θ + ϕ )} \qquad [ Math . 2 ]$$

A is the effective square of the piston, R is the conrod radius, φ is the crank angle and θ is the angle of the rod connected to the piston (see FIG. 6A).

The pressure determined according to the above described method can be used to determine whether it deviates from a target pressure to find out whether the timing of the combustion phase is shifted. In other words, the above described method for correcting/adjusting the amount of injected non-combustible fluid can either use one or more pressure sensors or the method for determining the combustion pressure as described in connection with FIGS. 6A and 6B or a combination thereof.

While the above describes a particular order of operations performed by certain aspects and examples, it should be understood that such order is exemplary, as alternatives may perform the operations in a different order, combine certain operations, overlap certain operations, or the like. References in the specification to a given aspect indicate that the aspect described may include a particular feature, structure, or characteristic, but every aspect may not necessarily include the particular feature, structure, or characteristic. The features which are described herein and which are shown by the Figures may be combined. The herein described and claimed subject-matter shall also entail these combinations as long as they fall under scope of the independent claims.

It should again be noted that the description and drawings merely illustrate the principles of the proposed methods, devices and systems. It will thus be appreciated that those skilled in the art will be able to devise various arrangements that, although not explicitly described or shown herein, embody the principles of the claimed subject-matter and are included within its spirit and scope.

Furthermore, it should be noted that steps of various above-described methods and components of described systems can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

In addition, it should be noted that the functions of the various elements described herein may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

Finally, it should be noted that any block diagrams herein represent conceptual views of illustrative circuitry embodying the principles of the claimed subject-matter. Similarly, it will be appreciated that any flow charts, flow diagrams, state transition diagrams, pseudo code, and the like represent various processes which may be substantially represented in computer readable storage medium and so executed by a computer or processor, whether or not such computer or processor is explicitly shown.

### REFERENCE SIGNS LIST

1 combustion chamber
2 piston
3 connecting rod
4 intake port
5 exhaust port
6 intake valve
7 exhaust valve
8 fuel injector
9 non-combustible fluid/water injector
10 intake valve phasing actuator
11 exhaust valve phasing actuator
12 spark ignition unit, 12a spark plug, 12b ignition coil
13 controller
14 cylinder wall
15 (water) tank
16 (water) pump
17 (water) pipe
18 signal line
19 pressure determining means
20 pressure sensor
21 feedforward control section
22 feedback control section
22a comparison section
22b gain
22c varying section
23 merging unit
24 output unit
25 crank shaft
26a crank angle sensor (detector for crank shaft teeth)
26b tooth/teeth of crank shaft
100 cylinder
101 (water) injection device

1. A method for controlling injection of a non-combustible fluid into an internal combustion engine, the internal combustion engine includes at least one cylinder at least one non-combustible fluid injector, at least one combustion phase determining means, and at least one control unit; the method comprising the steps of:
determining the combustion phase by the combustion phase determining means,
determining the amount of non-combustible fluid to be injected depending on the combustion phase.

2. The method according to claim 1, wherein the combustion phase determining means determines a pressure in the cylinder, and the control unit determines the combustion phase by comparing said determined pressure with a target pressure.

3. The method according to claim 1, wherein the control unit determines an amount of the non-combustible fluid to be injected by feedforward control and corrects the amount of the non-combustible fluid to be injected based on the determined combustion phase by feedback control.

4. The method according to claim 1, wherein the control unit:
determines the amount of non-combustible fluid to be injected based on an internal combustion engine state,
determines a pressure within the cylinder by the combustion phase determining means being a pressure determining means,
compares said determined pressure with the target pressure for determining the combustion phase, and
corrects the amount of non-combustible fluid to be injected based on the comparison result.

5. The method according to claim 1, wherein the control unit repeatedly performs at least the steps of determining the pressure within the cylinder, comparing the determining pressure with a target pressure and correcting the amount of non-combustible fluid to be injected, wherein the corrected amount of non-combustible fluid to be injected is stored for using it in a subsequent combustion cycle.

6. The method according to claim 1, wherein the control unit reduces the amount of non-combustible fluid to be injected compared to the amount determined by feedforward control when the determined combustion phase is delayed compared to a target combustion phase.

7. The method according to claim 1, wherein the combustion phase determining means is a pressure sensor installed within the cylinder and/or a crank angle sensor obtaining a crank angle based on which the control unit calculates the combustion pressure.

8. The method according to claim 1, the internal combustion engine is a gasoline engine.

9. A control unit of an internal combustion engine configured to carry out the method according to claim 1.

10. An internal combustion engine including the control unit according to claim 9.

11. A computer program product storable in a memory comprising instructions which, when carried out by a computer, cause the computer to perform the method according to claim 1.

12. A computer-readable storage medium comprising instructions which, when executed by a computer, cause the computer to carry out the method according to claim 1.
